(19) United States
(12) Patent Application Publication
(10) Pub. No.: US 2026/0002564 A1
(43) Pub. Date: Jan. 1, 2026

(54) DUST BOOT AND SUSPENSION ASSEMBLY INCLUDING THE DUST BOOT

(71) Applicant: RB Distribution, Inc., Colmar, PA (US)

(72) Inventor: Brian Ramsey, Colmar, PA (US)

(73) Assignee: RB Distribution, Inc., Colmar, PA (US)

(21) Appl. No.: 18/754,716

(22) Filed: Jun. 26, 2024

(51) Int. Cl. F16C 11/06; B60G 7/00

(52) U.S. Cl. CPC F16C 11/0633; B60G 7/005; B60G 2204/416; B60G 2204/4308

(57) ABSTRACT

A dust boot having an open end that includes an embedded mechanical fastener that secures the boot to a ball joint assembly and a ball joint assembly configured to engage with the embedded mechanical fastener.

### BACKGROUND

Vehicle suspension parts, such as ball joints, are frequently enclosed in a rubber or polyurethane boot or casing to prevent dirt and debris from entering the assembly. This boot can become damaged from road debris or during removal of the part. In either case, replacement of the boot usually requires stretching the boot for installation on the part. Frequently, the installer uses a tool to assist in stretching the boot and the tool causes damage to the boot during installation.

It is known to provide a split replacement boot that does not require the same stretching force; however, the effectiveness of this approach can depend on the flexibility of the boot and the reliability of the closing method.

In view of the above, it is desired to have a boot or cover that is not split and is not damaged by the installation technique.

### SUMMARY OF THE INVENTION

The potential for damage resulting from stretching the boot during application is addressed by a boot having an integrated fastener that engages a portion of the ball joint housing and retains the boot to the housing with a positive mechanical force.

### BRIEF DESCRIPTION OF THE DRAWINGS

FIG. 1 illustrates a ball joint assembly having dust boot according to a first embodiment;

FIG. 2 illustrates the ball joint assembly of FIG. 1 with the dust boot exploded up from the lower ball joint assembly;

FIG. 3 illustrates the ball joint assembly of FIG. 1 with a fragmentary section to reveal a mechanical connection between the lower ball joint assembly and the dust boot of FIG. 1;

FIG. 4 illustrates a dust boot according to a second embodiment exploded up from the lower ball joint assembly;

FIG. 5 illustrates the boot according to the second embodiment on the lower ball joint assembly with a fragmentary section to reveal the mechanical connection between the lower ball joint assembly and the dust boot according to the second embodiment;

FIG. 6 illustrates a dust boot according to a third embodiment exploded up from the lower ball joint assembly;

FIG. 7 illustrates the boot according to the third embodiment assembled on the lower ball joint assembly with a fragmentary section to reveal the mechanical connection with the lower ball joint assembly;

FIG. 8 is an enlarged view of the encircled area on FIG. 7;

FIG. 9 illustrates a dust boot according to a fourth embodiment exploded up from the lower ball joint assembly;

FIG. 10 illustrates the boot according to the fourth embodiment assembled on the lower ball joint assembly with a fragmentary section to reveal the mechanical connection with the lower ball joint assembly;

FIG. 11 is an enlarged view of the encircled area on FIG. 10;

FIG. 12 illustrates the boot according to the fifth embodiment assembled on the lower ball joint assembly with a fragmentary section to reveal the mechanical connection with the lower ball joint assembly;

FIG. 13 illustrates a dust boot according to the fifth embodiment exploded up from the lower ball joint assembly;

FIG. 14 is a section along the line 14-14; and,

FIG. 15 is an enlarged view of the encircled area on FIG. 14.

### DETAILED DESCRIPTION

The dust boots illustrated in the drawings will be described in more detail with reference to the drawings figures wherein the same or like structural features are identified with the same numeral.

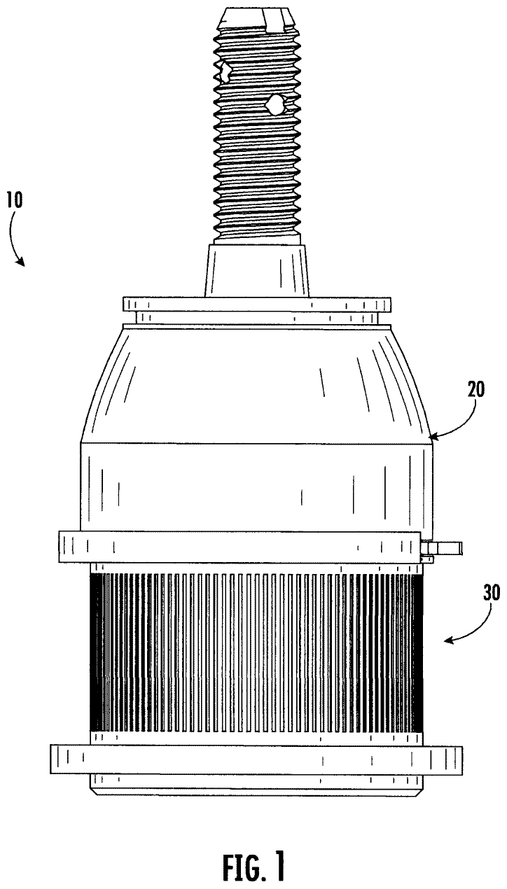

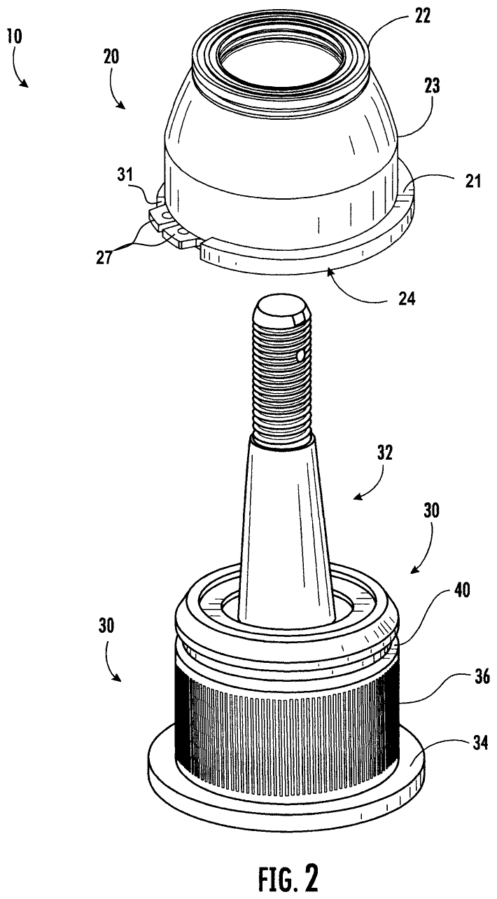

A typical ball joint assembly 10, as shown in FIG. 1, usually includes a dust boot 20 that is secured to the lower assembly 30, which includes the ball joint and is inserted in a defined aperture in a predetermined suspension component. With reference to the exploded view in FIG. 2, it can be seen that the lower assembly 30 included a tapered stem 32 that connects with a predesignated suspension component, a shoulder 34 that is dimensioned to abut a predetermined suspension component, a plurality of ridges or groves 36 that establish an interference fit the defined aperture in a predetermined suspension component, and an upper portion 38 that is dimensioned and configured to protrude from a predetermined suspension component so that the recess or groove 40 is exposed. The recess 40 is dimensioned to receive a lip associated with the lower end 24 of boot 20 and retain the boot 20 on the lower assembly 30.

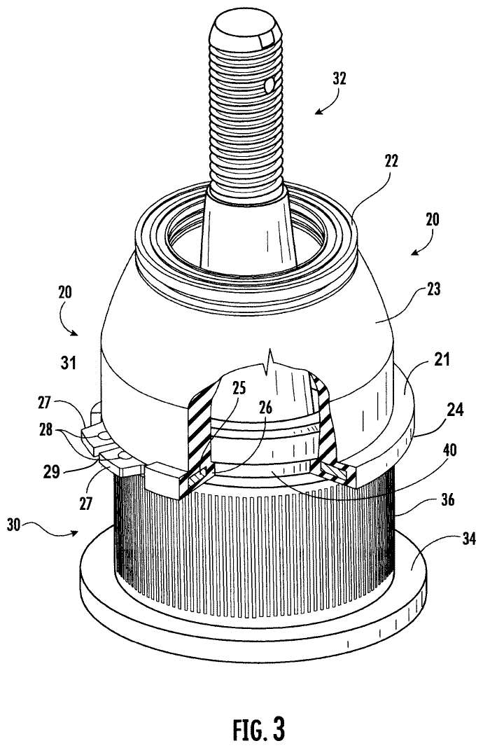

The details of the first embodiment of the dust boot will be provided with reference to FIG. 3. The lower assembly 30 is as described above. The boot 20 is molded from a rubber or polyurethane compound or a similar compound that will permit some stretching go the lower end 24. The fastener 25 is a split ring which is inwardly biased and molded in the lower end 24 of the boot 20. In addition to the fastener 25, the lower end 24 has an interior lip 26, which is dimensioned to fit in the recess or groove 40. The interior lip 26 defines a first interior circumference for the lower 2 end. The fastener 25 is embedded in the lower end 24 which has an outer perimeter with two exposed tabs 27 that are spaced from each other to define a tool gap 29. Each of the exposed tabs 27 has an aperture 28 for insertion of a tool for spreading the exposed tabs 27. Spreading the exposed tabs 27 expands the interior circumference of the lower end 24 of the boot 20 so the lip 26 passes over the upper portion 38 and can be inserted in groove 40. Releasing the tabs 27 cause the fastener 25 to spring back to the relaxed state and apply a mechanical force to retain the lip 26 in the groove 40. Alternatively, the exposed tabs 27 can be spread with a duck bill plier to expand the interior circumference of the lower end 24 of the boot 20 and insert the lip 26 in groove 40. In either instance, releasing the exposed tabs 27 will result in an applied mechanical force to retain the lip 26 in the groove 40.

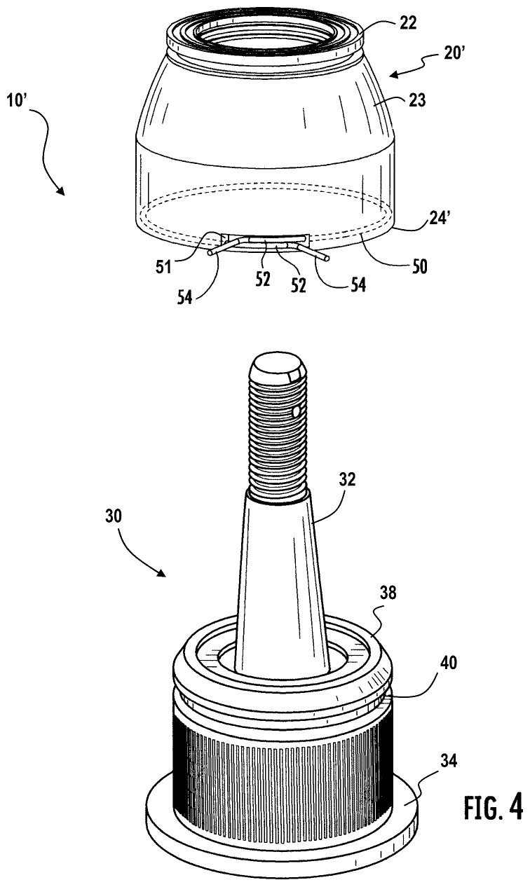

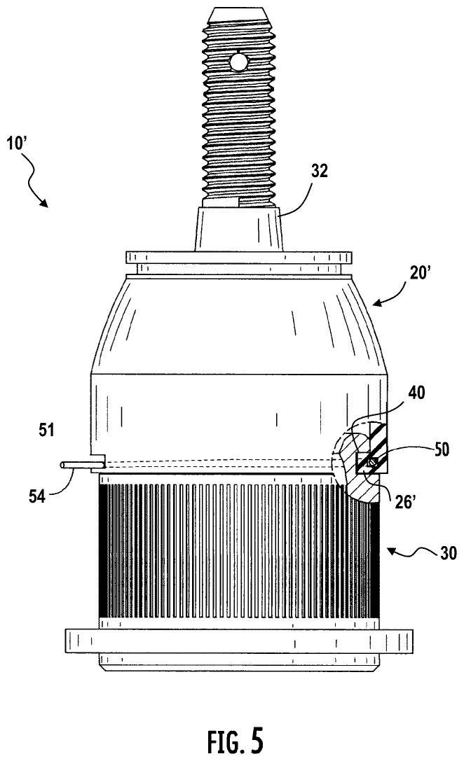

The details of a second embodiment of the dust boot will be provided with reference to FIGS. 4 and 5. In this embodiment, the lower assembly 30 is similar to the one described above. However, the interior circumference of the lower end 24 of boot 20 has a different expansion element, which is different. As shown in FIGS. 4 and 5, the expansion element in this embodiment is an embedded spring metal ring 50 with overlapping ends 52 that have exposed tabs 54. The exposed tabs 54 can be gripped and compressed toward each other with a tool, such as pliers, to expand the lower end 24 of the boot 20 over the upper portion 38 and insert the lip 26 in groove 40. The exposed tabs 54 can be drawn together in any fashion that spreads the lower end 24 of the boot 20 so it passes over the upper portion 38 and the lip 26 is inserted in groove 40. Regardless of the manner of spreading the tabs 54, the spring 50 will bias the overlapping ends 52 to their original positions and apply a mechanical force for retaining the lip 26 in the groove 40.

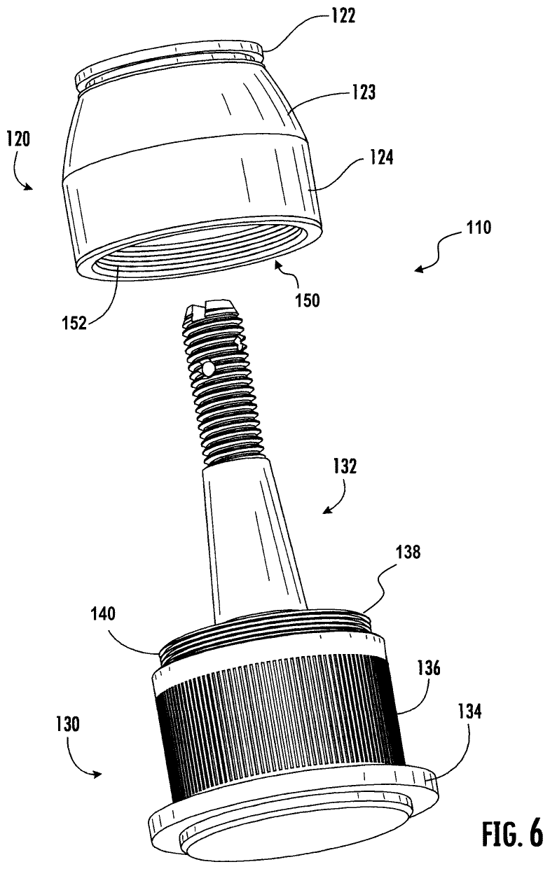

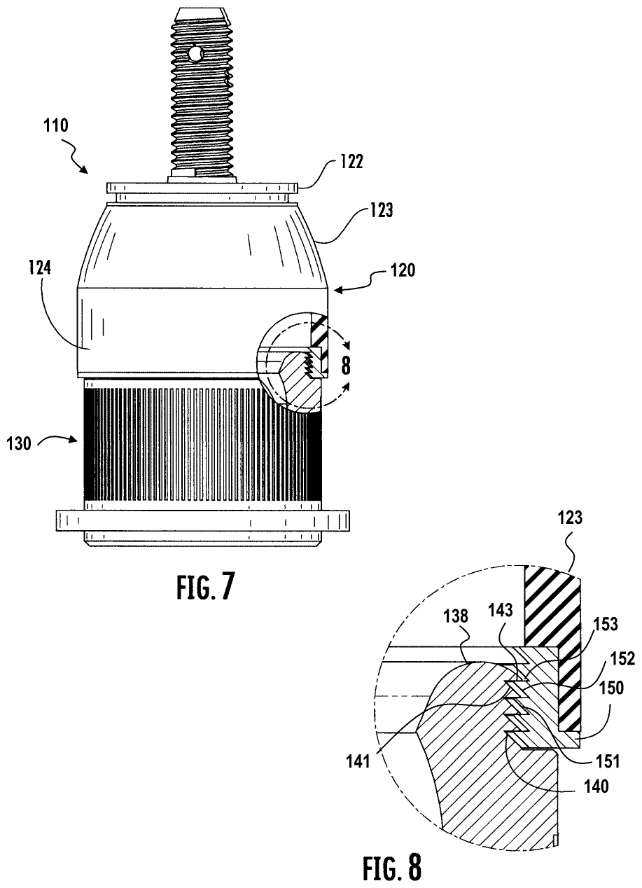

The details of a third embodiment of the dust boot 120 will be provided with reference to FIGS. 6 through 8. This embodiment differs from the previous embodiments by having an embedded threaded connector 200 in the lower end 124 of the dust boot 120 for mechanically joining the boot 120 with the lower assembly 130. Complementary threads 240 are provided on the lower assembly 130 above the ridges or grooves 136. The boot 120 can be secured to the lower assembly 130 with a threading motion that engages the complementary threads without requiring any expansion or stretching of the boot 120.

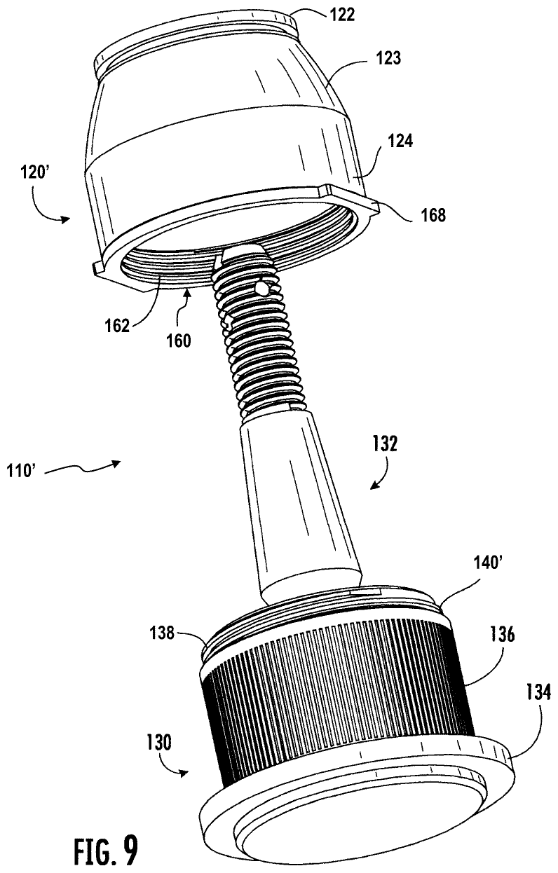

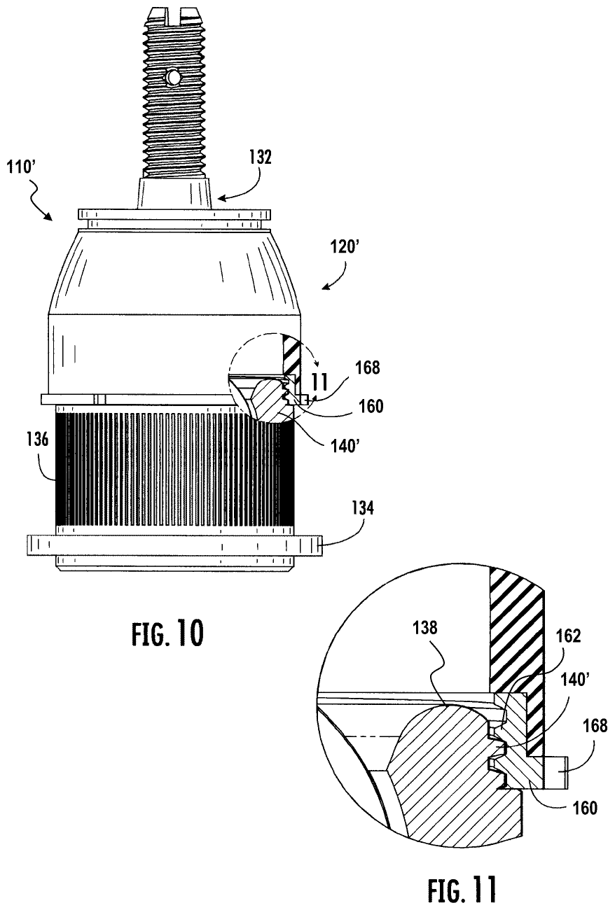

The details of a forth embodiment of the dust boot will be provided with reference to FIGS. 9 through 11. This embodiment has an embedded threaded connector 300 and a pair of external lands or projections 302 that are radially opposite to each other and configured for gripping by a tool. The external lands or projections 302 allow the use of a tool for tightening the boot 220 on the threads 240 of the lower assembly 130 and confirming a mechanical connection between the boot 220 and the lower assembly 130. As with the previous third embodiment, the threads 240 are formed after the ridges or grooves 136.

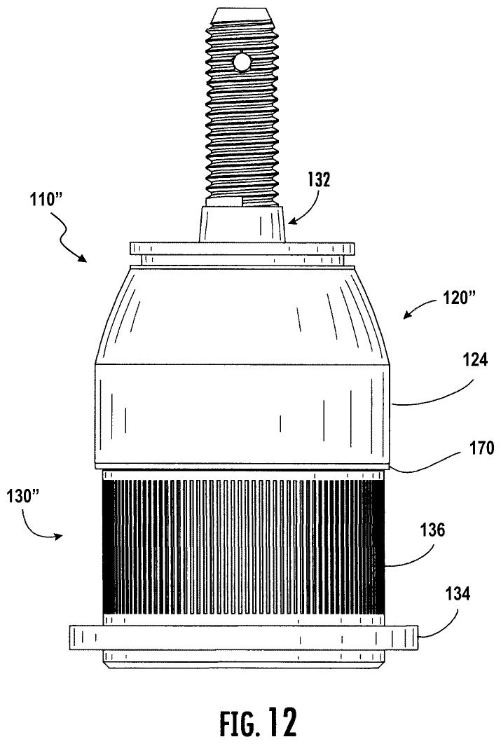

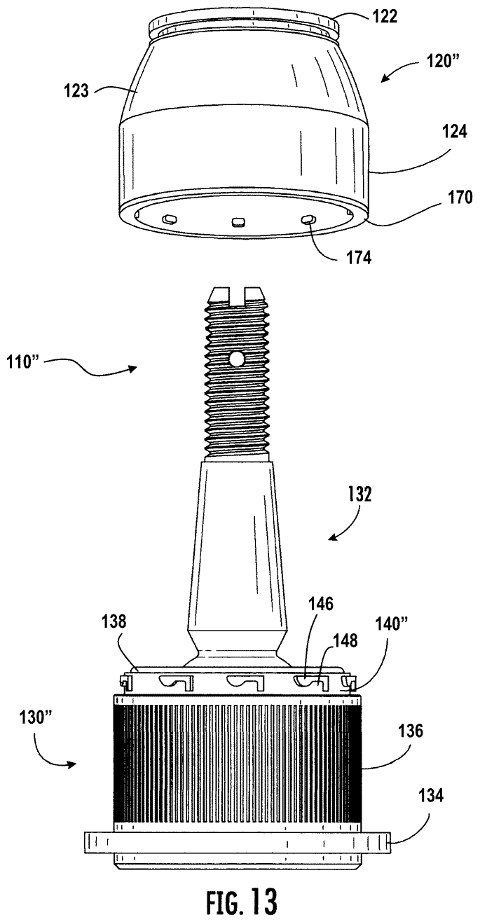

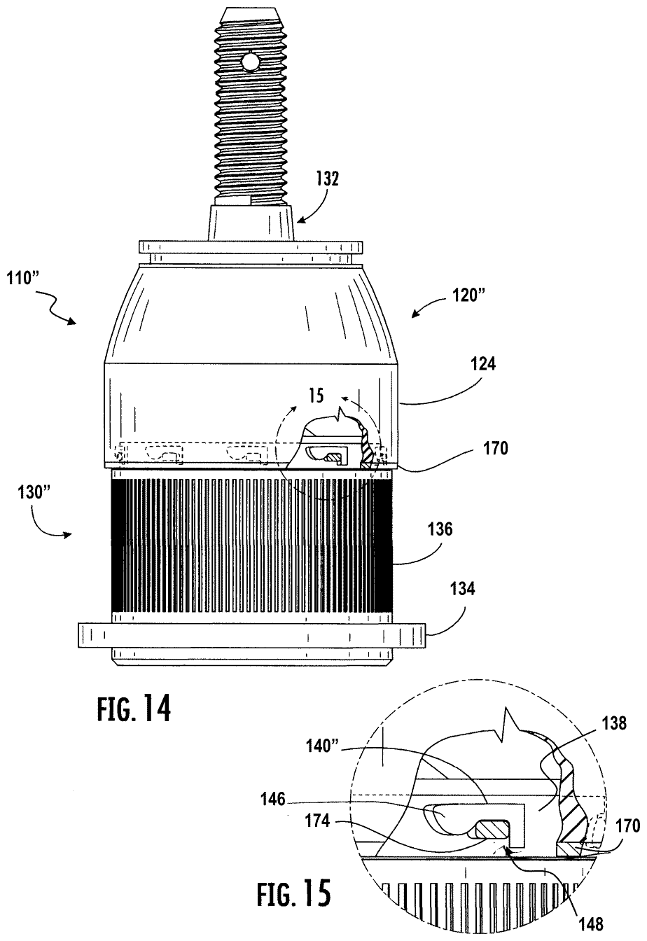

The details of a fifth embodiment of the dust boot will be provided with reference to FIGS. 12 through 15. In this embodiment, one component, here illustrated as the boot 320, has an embedded ring 400 with a series of projections 410. The other component, here illustrated as the lower assembly 230, has an area 340 above the grooves or ridges 236 with a series of grippers 420 that include a ramping surface 422 and a recess 424. The grippers 420 are configured to engage with the projections 410. The components 230 and 320 are assembled by placing the projections 410 between the grippers 420 and turning the component 320 so the projection 410 contact the ramping surfaces 422 and pass into the recesses 424, see FIG. 13. As shown in FIGS. 14 and 15 the projections 410 and recesses 424 interlock to form a mechanical connection.

What is claimed is:

1. A dust boot comprising:
a dome shaped body with open ends and an interior cavity defined between the open ends;
wherein a predetermined one of the open ends includes an embedded mechanical fastener configured to engage with a predetermined portion of a ball joint assembly and establish a fixed relationship.

2. The dust boot of claim 1, wherein the embedded mechanical fastener has a first circumference and ends that extend beyond a circumference defined by the designated open end.

3. The dust boot of claim 2, wherein the ends of the embedded mechanical fastener are moved apart from each other to define a second circumference for the designated open end.

4. The dust boot of claim 2, wherein the ends of the embedded mechanical fastener are moved toward each other to define a second circumference for the designated open end.

5. The dust boot of claim 1, wherein the embedded mechanical fastener has threads that extend into the interior cavity and the predetermined portion of a ball joint assembly configured to establish a fixed relationship with the dome shaped body has threads that complement the threads that extend into the interior cavity.

6. The dust boot of claim 5, wherein the embedded mechanical fastener has at least two projections that extend outside the dome shaped body.

7. The dust boot of claim 6, wherein the at least two projections are radially opposite to each other.

8. The dust boot of claim 1, wherein the embedded mechanical fastener has plurality of projections or grippers and the predetermined portion of a ball joint assembly a complementary plurality of the other of the projections or grippers.

9. A dust boot comprising:
a dome shaped, open ended body; and,
an integrated mechanical fastener positioned in an open end of the body is configured to connects with a ball joint housing in a mechanical connection.

10. A dust boot comprising:
a dome shaped, open ended body; and,
a mechanical fastener embedded in an open end,
wherein the mechanical element embedded in an open end is configured to engage the dome shaped body with a ball joint housing and assert a mechanical force that retains the body engaged with a ball joint housing.

11. A ball joint assembly comprising:
a stud portion configured for connecting with a vehicle suspension member and a ball opposite to the stud portion;
a housing that enclosed a portion of the ball; and
a boot that encloses at least a portion of the stud and at least a portion of the housing,
wherein a portion of the housing is configured to couple with the boot, and the boot has an embedded mechanical fastener that couples with the configured portion of the housing.

12. A suspension assembly comprising:
a housing containing a ball and stud configured for connecting with a suspension member; and,
an open ended, dome shaped body that has a mechanical element embedded in one open end,
wherein, the housing has a portion that is configured to couple with the body and the body has a complementary portion that is configured to engage the housing and assert a mechanical force that retains the body engaged with the housing.
